(19) United States
(12) Patent Application Publication
(10) Pub. No.: US 2014/0212141 A1
(43) Pub. Date: Jul. 31, 2014

(54) LIGHT OUTPUT APPARATUS AND METHOD

(71) Applicant: Electronics and Telecommunications Research Institute, Daejeon (KR)

(72) Inventors: Bong Kyu KIM, Daejeon (KR); Hyun Woo SONG, Daejeon (KR); Chang-Geun AHN, Daejeon (KR); Eun-ju JEONG, Daejeon (KR); Won Ick JANG, Daejeon (KR); Jong-Moo LEE, Sejong (KR); Hong-Seok SEO, Daejeon (KR); Hyung Wook NOH, Daejeon (KR)

(73) Assignee: Electronics and Telecommunications Research Institute, Daejeon (KR)

(21) Appl. No.: 14/157,390

(22) Filed: Jan. 16, 2014

(30) Foreign Application Priority Data
Jan. 25, 2013 (KR) 10-2013-0008671
Aug. 30, 2013 (KR) 10-2013-0104205

(51) Int. Cl. H04B 10/50; H04J 14/02

(52) U.S. Cl. CPC H04B 10/50; H04J 14/02
USPC 398/82; 398/79

(57) ABSTRACT

Provided is a light output apparatus for increasing an output of an optical source. The light output apparatus includes a pulse generator generating a plurality of optical pulses, a pulse distributor dispersing the optical pulses generated from the pulse generator in time domain, an optical coupler allowing the dispersed optical pulses to travel along one path. The light output apparatus also includes an optical amplifier amplifying output intensities of optical pulses output from the optical coupler, a pulse separator separating the optical pulses amplified by the optical amplifier for each corresponding wavelength, a time delaying unit individually delaying each of the optical pulses separated for each wavelength to be reached a combination point at an identical time, and a pulse combiner combining the optical pulses arrived at the combination point at the identical time.

### CROSS-REFERENCE TO RELATED APPLICATIONS

This U.S. non-provisional patent application claims priority under 35 U.S.C. §119 of Korean Patent Application No. 10-2013-0008671, filed on Jan. 25, 2013, and Korean Patent Application No. 10-2013-0104205, filed on Aug. 30, 2013, the entire contents of which are hereby incorporated by reference.

### BACKGROUND OF THE INVENTION

The present invention disclosed herein relates to a technology for output a light from an optical source and more particularly, to a light output apparatus and method for increasing an instant output of an optical source.

Typically, a high power optical source is necessary for a photo-acoustic imaging device, a medical device, or an industrial laser.

In order to increase an output of an optical source, an ultrashort pulse output amplification technique, such as a multistage amplification technique or a chirped pulse amplification (CPA) scheme, is well known in the field. However, there is limitation in increasing an intensity of an instant output or an intensity of an optical pulse output.

### SUMMARY OF THE INVENTION

The present invention provides a light output apparatus and method capable of increasing an output of an optical source.

Embodiments of the present invention provide light output apparatuses including: a pulse generator generating a plurality of optical pulses; a pulse distributor dispersing the optical pulses generated from the pulse generator in time domain; an optical coupler allowing the dispersed optical pulses to travel along one path; an optical amplifier amplifying output intensities of optical pulses output from the optical coupler; a pulse separator separating the optical pulses amplified by the optical amplifier for each corresponding wavelength; a time delaying unit individually delaying each of the optical pulses separated for each wavelength to be reached a combination point at an identical time; and a pulse combiner combining the optical pulses arrived at the combination point at the identical time.

In other embodiments of the present invention, light output apparatuses include: a wideband pulse generator generating optical pulses by driving a wideband optical source with a pulse; a wavelength divider dividing the optical pulses for each wavelength; a dispersion time delay individually time-delaying of the wavelength divided optical pulses to allow the optical pulses to be dispersed in time domain; an optical multiplexer allowing the dispersed optical pulses to travel along one path; an optical amplifier amplifying output intensities of optical pulses output from the optical coupler; a pulse separator separating the optical pulses amplified by the optical amplifier for each corresponding wavelength; a time delaying unit delaying the optical pulses separated respectively for each wavelength and allowing the optical pulses to reach a combination point at an identical time; and a pulse combiner combining the optical pulses arrived at the combination point at the identical time.

In still other embodiments of the present invention, light output methods include: dispersing generated optical pulses in time domain and allowing the dispersed optical pulses to travel along one path; amplifying output intensities of the optical pulses traveled along one path and separating the optical pulses for each corresponding wavelength; delaying individually the optical pulses separated for each wavelength and allowing the delayed optical pulses to reach a combination point at an identical time; and combining the optical pulses arrived at the combination point at the identical time and outputting a light having an output thereof increased.

In even other embodiments of the present invention, light output methods include: generating optical pulses by driving a wideband optical source as a pulse; dividing the generated optical pulses for each wavelength, individually time-delaying the divided optical pulses to allow the optical pulses to be dispersed in time domain; allowing the distributed optical pulses to travel along one path and amplifying output intensities of the optical pulses; separating the amplified optical pulses for each corresponding wavelength, individually delaying the separated optical pulses and allowing the delayed optical pulses to reach at a combination point at an identical time; and combining the optical pulses arrived at the combination point at the identical time to output a light having an output thereof increased.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a high output optical source using a typical multistage amplification technique;

FIG. 2 is a typical ultrashort pulse output intensity amplifier in a chirped pulse amplification (CPA) scheme;

FIG. 3 illustrates a principle of increasing output intensity of an optical amplifier according to an embodiment of the present invention;

FIG. 4 illustrates a structure of a light output apparatus whose output intensity is increased according to an embodiment of the present invention;

FIGS. 5A and 5B illustrates operations of dispersing pulses in time domain by using a pulse generator and a pulse distributor according to embodiments of the present invention;

FIGS. 6A and 6B illustrates operations of increasing an output intensity by using amplified pulse signals according to embodiments of the present invention; and

FIG. 7 entirely illustrates a high output optical source including an optical signal amplifier according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

It will be understood that when elements and lines are referred to as being “connected to” or “coupled to” a target element block, it may be directly connected or coupled to the target element block or indirectly connected or coupled to the target element block through intervening elements.

Also, the same or similar reference numerals provided in each drawing denote the same or similar components. In some drawings, connection relations between devices and lines are merely shown for efficient description of the technical spirit, and therefore other devices or circuit blocks may be further provided.

Exemplary embodiments set forth herein may include complementary embodiments thereof, and it will be noted that a general operation and detailed description of material property of an optical source system may be omitted so as not to obscure the essential point of the invention.

Generally, an optical amplifier is widely used as a typical method of increasing an output of an optical source.

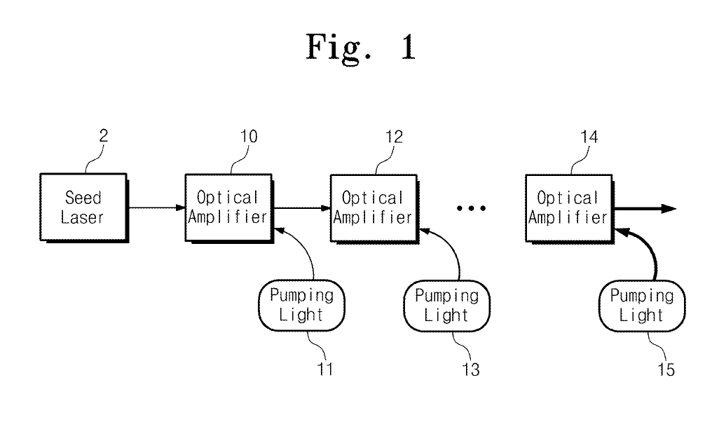

FIG. 1 illustrates a high output optical source by using a typical multistage amplification technology.

Referring to FIG. 1, a configuration is illustrated which employs an optical amplifier as a method of increasing an output of an optical source. A plurality of stages of optical amplifiers 10, 12 and 14 are connected to obtain a high output intensity from a light output from a seed laser 2. Energy is applied to the optical amplifiers 10, 12 and 14 in order to amplify an optical signal. For example, pumping lights 11, 13, and 15 are applied as the energy, such as electrical energy or optical energy.

At this time, in order to increase an output intensity, the pumping is performed with high optical energy, and a pulse type optical source rather than a continuous wave optical source is favorable to obtain a high instant output in terms of the output intensity.

However, even for the instant output, there is a limitation in the high optical pumping energy. Also, since a pulse having a very high instant output causes a nonlinear phenomenon in a gain medium region of an optical amplifier, there is a limit to increase the intensity of the instant output.

Accordingly, it is efficient to lower an intensity of an optical output inside the optical amplifier for increasing the instant output.

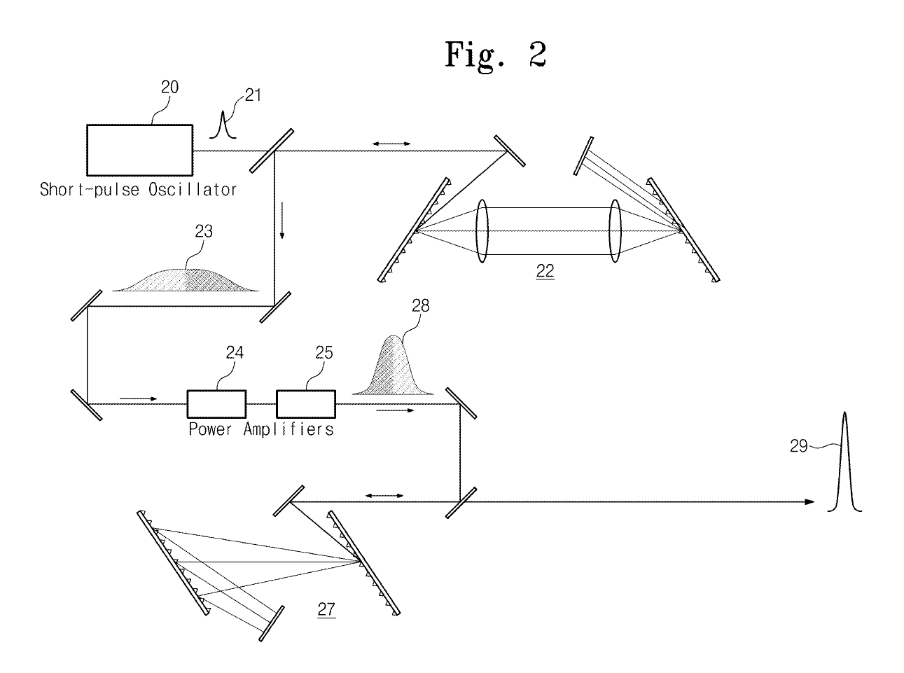

FIG. 2 illustrates a typical ultrashort pulse output intensity amplifier in a chirped pulse amplification (CPA) scheme.

Referring to FIG. 2, an optical pulse 21 from a short pulse oscillator 20 is reflected by a first optical element 22 and passes through a mirror to be output as an optical output 23 having a wide pulse width. Then the optical output 23 is amplified by two-stage power amplifiers 24 and 25 to be output as an amplified optical output 28. The amplified optical output 28 has a pulse width reduced while passing through a second optical element 27, and then is output as a final optical output 29.

The CPA scheme of FIG. 2 takes a method of broadening a pulse width of an optical pulse in time domain, amplifying the optical pulse, and then reducing the pulse width again in order to lower an optical output intensity inside the optical amplifier. However, the optical output scheme according to FIG. 2 is a typically used scheme for obtaining a high output optical signal by using an optical pulse signal having a psec (10⁻¹² second) or smaller pulse width. This scheme is a CPA scheme proposed by Rochester University in 1985, which is normally used in an optical output field.

The CPA scheme is very efficient to increase an instant output intensity of a very short pulse having a psec or smaller pulse width output from an optical source, but is not proper to increase an output intensity of an optical pulse having a nsec (10⁻⁹ second) or greater pulse width and a very narrow linewidth

Accordingly, a technique is necessary which is easily implemented and can increase an optical output intensity.

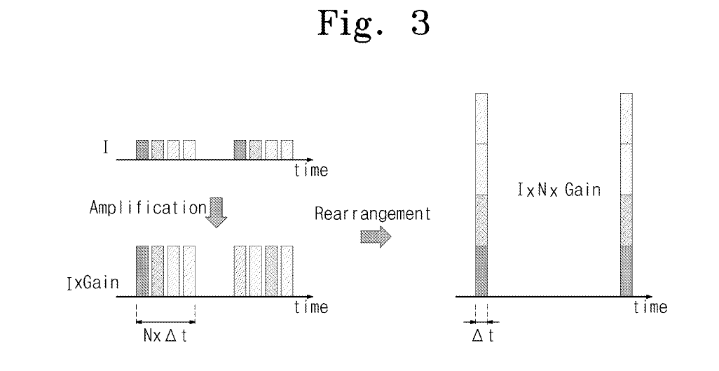

FIG. 3 illustrates a principle of increasing an output intensity of an optical amplifier according to an embodiment of the present invention.

FIG. 3 shows an example of dispersing a plurality of pulses in time domain. It is efficient not to have optical pulses superimposed by allowing a time interval between the optical pulses to be wider than a pulse width of each of the optical pulses. After the pulses dispersed in the time domain are amplified by an optical amplifier and the amplified optical pulses are gathered in the same time domain, a final instant output intensity is increased by multiples of multiplication of a gain coefficient of the optical amplifier and the number of the optical pulses.

At this time, since each optical pulse is dispersed in the time domain, input power for the optical amplifier is low. Accordingly, gain coefficient characteristics in the optical amplifier become improved. Also, since a nonlinear effect inside a gain medium is reduced, an output intensity of the optical pulse may be increased.

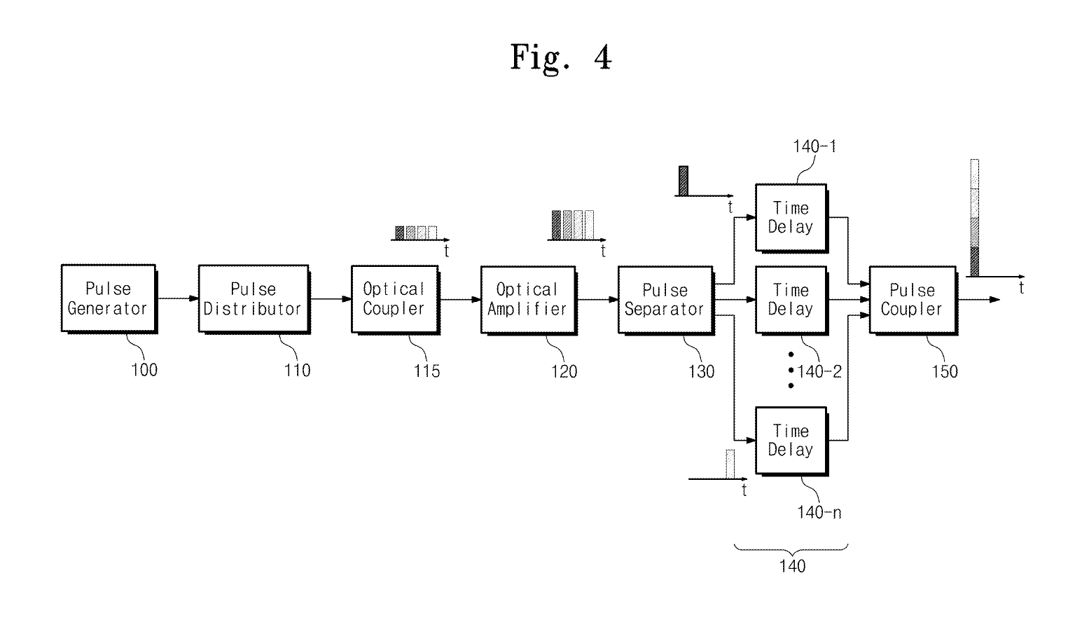

FIG. 4 illustrates a structure of an optical amplifier whose output intensity is increased according to an embodiment of the present invention.

Referring to FIG. 4, a light output apparatus includes a pulse generator 100, a pulse distributor 110, an optical multiplexer 115, an optical amplifier 120, a pulse separator 130, a time delaying unit 140, and a pulse combiner 150.

The pulse generator 100 generates a plurality of optical pulses, and the pulse distributor 110 disperses the optical pulses generated by the pulse generator 100 in time domain.

The optical multiplexer 115 allows the dispersed optical pulses to travel along one path, and the optical amplifier 120 amplifies output intensities of the optical pulses output from the optical coupler 115.

The pulse separator 130 separates the optical pulses amplified by the optical amplifier 120 for each corresponding wavelength.

The time delaying unit 140 individually delays each of the separated optical pulses to allow them to reach a combination point at an identical time.

The pulse combiner 150 combines the optical pulses arrived at the combination point at the identical time.

In a light output apparatus of FIG. 4, the plurality of optical pulses having different wavelengths generated in the pulse generator 100 are dispersed in the time domain, while passing through the pulse distributor 110 and the optical coupler 115. In this case, the optical pulses are not superimposed with each other as described in relation to FIG. 3.

The dispersed optical pulses are applied to the optical amplifier 120 and individually amplified. The amplified optical pulses are separated for each pulse or wavelength through the pulse separator 130.

The separated optical pulses are applied to a corresponding time delay line in the time delaying unit 140 and delayed by different times for each pulse. The optical pulses delayed by different times simultaneously arrived at an input end of the pulse combiner 150. The simultaneously arrived optical pulses are combined to increase an output intensity of the combined optical pulse.

Finally, the instant output is increased by spreading limited output characteristics of an optical amplifier for amplifying an output in the time domain.

Like this, an optical signal having a high output may be obtained by properly dispersing the optical signal in the time domain. Accordingly, an optical system having better characteristics may be obtained by efficiently configuring the light output apparatus, and minimization and cost reduction are enabled by a relatively simple configuration.

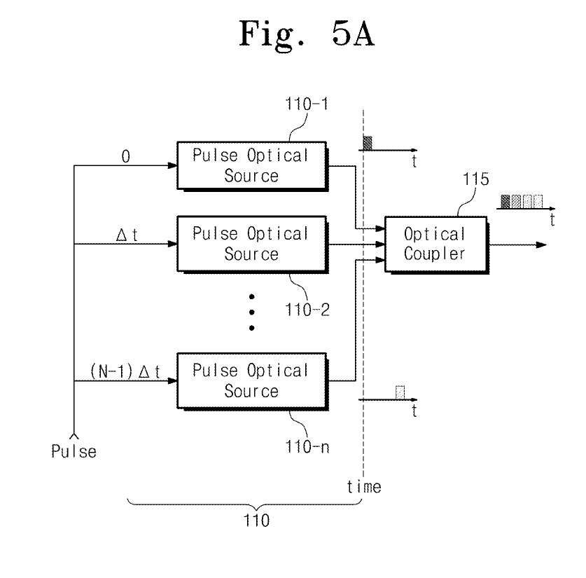

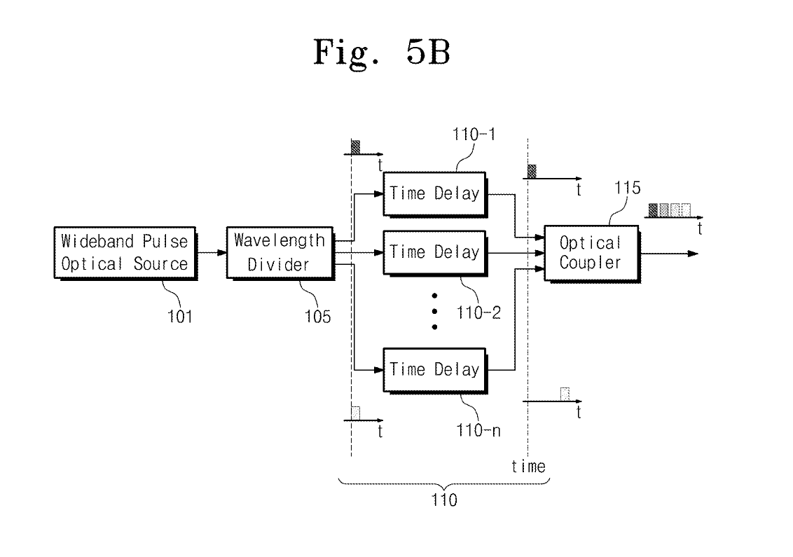

FIGS. 5A and 5B illustrate operations of dispersing optical pulses in the time domain by using the pulse generator and the pulse distributor according to embodiments of the present invention.

Referring to FIG. 5A, an optical signal output by driving an optical source with a pulse is output as a pulse type. At this time, after pulse signals having time differences (0, Δt, 2Δt, (N−1) Δt, where Δt≧pulse width) are applied to optical sources generating optical pulses having different wavelengths and combined, the optical pulses output from the optical coupler 115 are dispersed in the time domain and output. Here, the optical coupler may be implemented with a wavelength division multiplexing (WDM) coupler, an arrayed waveguide grating (AWG), and optical switching. An optical splitter may be also used as the optical coupler despite of optical loss.

FIG. 5B shows an example of using a wideband pulse optical source. Since a pulse signal output from the wideband pulse optical source 101 has various wavelength components, separation for each wavelength is enabled by using a wavelength divider 105, such as the AWG and the WDM coupler. The pulses separated for each wavelength experience difference time delays (0, Δt, 2Δt, . . . , (N−1) Δt, where Δt≧pulse width) through a time delayer and are combined at the optical coupler 115. Then pulses output from the optical coupler 115 may be dispersed in the time domain and output.

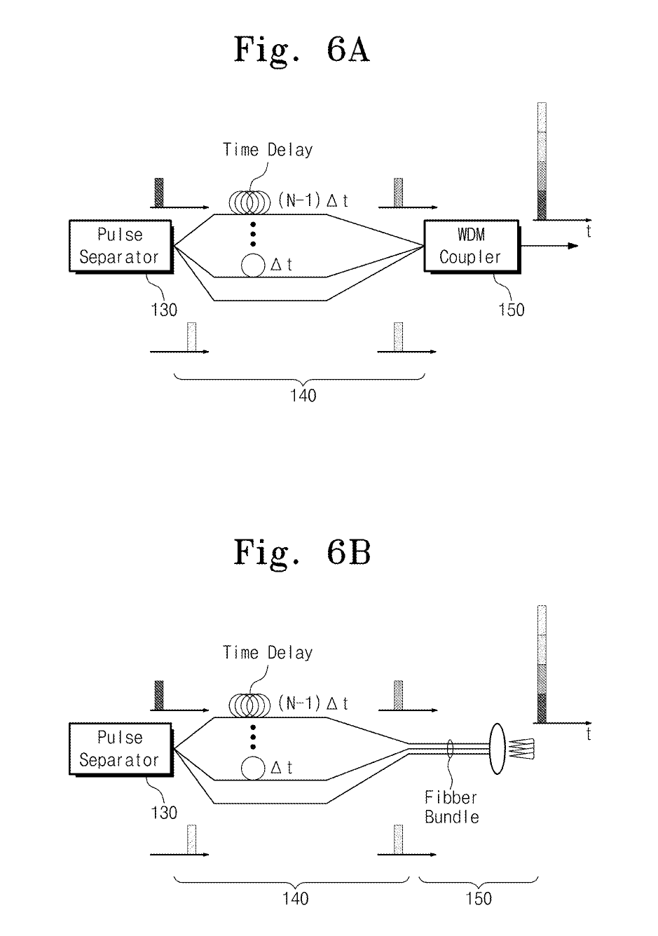

FIGS. 6A and 6B illustrate operations of increasing an output intensity by using amplified pulse signals according to embodiments of the present invention.

Referring to FIG. 6A, the amplified pulses having different wavelengths are separated to pass different paths for each pulse (or wavelength) by using the pulse separator 130. The optical pulses experience different time delays through the time delaying unit 140 in order to be able to simultaneously arrive at the input end of a WDM coupler 150. When the pulses arrived at the input end of the WDM coupler 150 are combined by using the WDM coupler 150 or an AWG without loss, an amplitude of the pulse is increased. Here, the pulse separator may be the WDM coupler 150, an AWG, or an optical gating element.

Referring to FIG. 6B, when the amplified optical pulses are simultaneously arrived at a specific point, the optical pulses may be combined in spatial domain by using a fiber bundle or a free space without a WDM coupler. FIG. 6B shows an example that the pulse separator is implemented by using a fiber bundle.

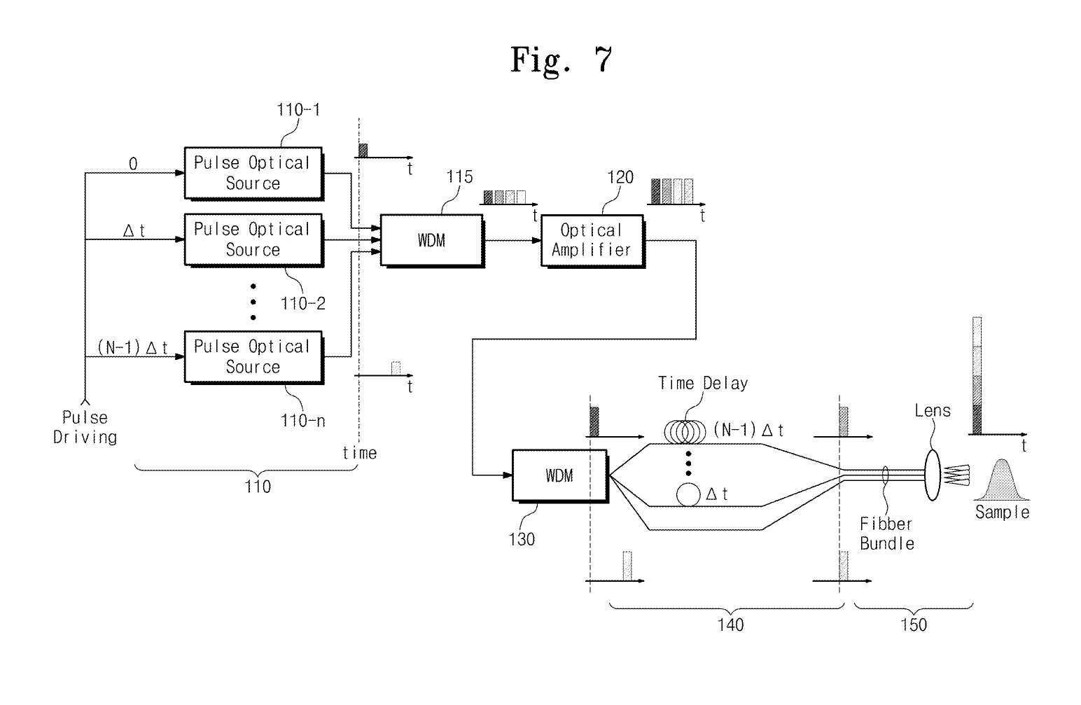

FIG. 7 illustrates a high output optical source including an optical amplifier according to another embodiment of the present invention.

FIG. 7 shows a structural diagram of a high output optical source including the optical amplifier which is applicable to an application system using a wide beam having a mm level pulse width, such as an optoacoustic imaging system.

In FIG. 7, the pulse distributor 110 of FIG. 5A is applied to a front end of the optical amplifier 120. A WDM coupler is used as the optical coupler 115. The time delaying unit 140 and the pulse combiner 150 of FIG. 6B are applied to a rear end of the optical amplifier 120. A WDM coupler is used as the pulse separator 130.

According to FIG. 7, since an optical output may be increased while the number of optical amplifiers or an output intensity of a pumping optical source is minimized, the high output optical source may be usefully applied to an industrial laser or a medical laser which uses the high output optical source whose pulse width is nsec or greater. That is, practicability of the high output optical source is increased by efficiently implementing an optical amplifier or a pumping optical source which has the largest volume and costs a lot of expense for obtaining the high output optical source.

As described above, a cost and a size of the optical amplifier or a high output optical source can be minimized by maximizing an output intensity obtainable from an optical amplifier. Therefore, cost reduction and mobility can be improved for various application devices.

Also, by enhancing output intensity of an existing optical fiber amplifier which has low applicability due to low output intensity thereof, it is expected that applicability of the optical fiber amplifier to an industrial laser or an optoacoustic imaging system becomes very high and economic feasibility can be enhanced due to increase of availability of the optical fiber amplifier.

The photo-acoustic imaging system may be implemented by application of an optical signal amplification technique of the above described light output apparatus.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A light output apparatus comprising:
a pulse generator generating a plurality of optical pulses;
a pulse distributor dispersing the optical pulses generated from the pulse generator in time domain;
an optical multiplexer allowing the dispersed optical pulses to travel along one path;
an optical amplifier amplifying output intensities of optical pulses output from the optical multiplexer;
a pulse separator separating the optical pulses amplified by the optical amplifier for each corresponding wavelength;
a time delaying unit individually delaying each of the optical pulses separated for each wavelength to be reached a combination point at an identical time; and
a pulse combiner configured to combine the optical pulses arrived at the combination point at the identical time.

2. The light output apparatus of claim 1, wherein the pulse generator is a multi-pulse generator generating multiple optical pulses having different frequencies.

3. The light output apparatus of claim 1, wherein the pulse distributor allows the optical pulses to be distributed in a time divisional manner in the time domain by respectively adjusting output times of the optical pulses.

4. The light output apparatus of claim 1, wherein the optical multiplexer comprises at least one of a wavelength division coupler of a wavelength division multiplexing (WDM) coupler or an arrayed waveguide grating (AWG), an optical splitter, and an optical gating (switching) element.

5. The light output apparatus of claim 1, wherein the pulse separator comprises at least one of a WDM coupler, an AWG, and an optical grating (switching) element.

6. The light output apparatus of claim 1, wherein the pulse combiner comprises a wavelength division coupler of a WDM coupler or AWG type.

7. The light output apparatus of claim 1, wherein the pulse combiner is an optical fiber bundle combining the optical pulses which are respectively time-delayed in spatial domain.

8. A light output apparatus comprising:
a wideband pulse generator generating optical pulses by driving a wideband optical source with a pulse;
a wavelength divider dividing the optical pulses for each wavelength;
a dispersion time delay individually time-delaying of the wavelength divided optical pulses to allow the optical pulses to be dispersed in time domain;
an optical multiplexer allowing the dispersed optical pulses to travel along one path;
an optical amplifier amplifying output intensities of optical pulses output from the optical multiplexer;
a pulse separator separating the optical pulses amplified by the optical amplifier for each corresponding wavelength;
a time delaying unit delaying the optical pulses separated respectively for each wavelength and allowing the optical pulses to reach a combination point at an identical time; and
a pulse combiner combining the optical pulses arrived at the combination point at the identical time.

9. The light output apparatus of claim 8, wherein the optical multiplexer comprises a WDM coupler.

10. The light output apparatus of claim 8, wherein the optical multiplexer is a wavelength division multiplexer of a WDM coupler or AWG type.

11. The light output apparatus of claim 8, wherein the pulse separator comprises at least one of a WDM coupler, an AWG, and an optical gating element.

12. The light output apparatus of claim 11, wherein the pulse combiner is a wavelength division coupler of a WDM coupler or AWG type.

13. The light output apparatus of claim 11, wherein the pulse combiner comprises an optical fiber bundle combining the optical pulses which are respectively time-delayed in spatial domain.

14. The light output apparatus of claim 11, wherein the time delaying unit comprises time delaying elements as many as the number of the optical pulses separated for each wavelength.

15. The light output apparatus of claim 11, wherein the light output apparatus is applied to a photo-acoustic imaging system.

16. A light output method comprising:
dispersing generated optical pulses in time domain and allowing the dispersed optical pulses to travel along one path;
amplifying output intensities of the optical pulses traveled along one path and separating the optical pulses for each corresponding wavelength;
delaying individually the optical pulses separated for each wavelength and allowing the delayed optical pulses to reach a combination point at an identical time; and
combining the optical pulses arrived at the combination point at the identical time and outputting a light having an output thereof increased.

17. The light output method of claim 16, wherein the dispersion of the optical pulses in the time domain is performed through a pulse distributor.

18. The light output method of claim 16, wherein a process that the optical pulses are traveled along the one path is performed by using an optical coupler.

19. The light output method of claim 16, wherein the separating of the optical pulses for each corresponding wavelength is performed through a WDM coupler.

20. A light output method comprising:
generating optical pulses by driving a wideband optical source as a pulse;
dividing the generated optical pulses for each wavelength, individually time-delaying the divided optical pulses to allow the optical pulses to be dispersed in time domain;
allowing the distributed optical pulses to travel along one path and amplifying output intensities of the optical pulses;
separating the amplified optical pulses for each corresponding wavelength, individually delaying the separated optical pulses and allowing the delayed optical pulses to reach at a combination point at an identical time; and
combining the optical pulses arrived at the combination point at the identical time to output a light having an output thereof increased.
